(19) United States
(12) Patent Application Publication
(10) Pub. No.: US 2025/0309957 A1
(43) Pub. Date: Oct. 2, 2025

(54) UPLINK POWER CONTROL BASED ON BEAMFORMING

(71) Applicant: Huawei Technologies Co., Ltd., Shenzhen (CN)

(72) Inventors: Haoyuan Wei, Stittsville (CA); Mostafa Medra, Ottawa (CA); Mohammadhadi Baligh, Ottawa (CA)

(21) Appl. No.: 19/237,853

(22) Filed: Jun. 13, 2025

Related U.S. Application Data
(63) Continuation of application No. PCT/CN2022/139169, filed on Dec. 15, 2022.

(51) Int. Cl. H04B 7/06; H04W 52/14

(52) U.S. Cl. CPC H04B 7/0617; H04W 52/14

(57) ABSTRACT

Power control systems and methods are provided. Beamforming gain offset occurs in situations where downlink reference beams are different from uplink communication beams. Methods are provided of estimating beamforming gain offsets at the UE and the BS and incorporating these into a power control formula. At least one parameter relating to a beamforming gain offset between uplink and downlink beamformers at the UE and/or the BS is communicated between the UE and the BS. The UE transmits, and the BS receives, an uplink signal that has a transmit power that is based in part on the at least one parameter. The parameter can be a direct indication of one or more of the offsets, or can be another parameter that incorporates the effect of one or more of the offsets.

### CROSS REFERENCE

The application is a continuation of International Application No. PCT/CN2022/139169, filed on Dec. 15, 2022, the disclosure of which is hereby incorporated by reference in its entirety.

### TECHNICAL FIELD

The application relates to wireless communications generally, and more specifically to methods and systems of uplink power control.

### BACKGROUND

The frequency bands that will be used for the next-generation wireless communications include currently used frequency bands and higher frequency bands. The much higher frequency enables the employment of much smaller antenna elements. Then the base station (BS) and the user equipment (UE) can be equipped with more antenna elements and adopt more flexible beamforming. Beamforming is a technique that can focus the transmitted signal in a specific direction, so that the received power is higher than the omnidirectional transmission. The additional power received with a beamforming pattern, compared with the omnidirectional transmission, is called beamforming gain. Flexible beamforming is related to the ability to provide a trade-off between the beamforming gains and the beam shape. For example, a BS transmit (TX) beam might be designed to be as narrow as possible covering a small area around the UE and thereby provide the maximum possible gain. In another example, the BS TX beam might be designed to be wider to cover more area around the UE, in exchange for lower beamforming gain. The wider beam may be considered to be more robust to UE movements, measurement error, hardware impairments and other imperfections. For Uniform Linear Array (ULA) antennas, a discrete Fourier transform (DFT) matrix can be used to perform beamforming in a manner that maximizes beamforming gain, where each column in the DFT matrix is a beamformer that shapes the signal towards a certain angle or area. In a DFT beamforming, for any column selected as the beamformer, the phase difference between any two adjacent antenna elements is constant and an integer multiple of

$$\frac{2 π}{M}$$

where M is the number of antennas in the array. For Uniform Planar Arrays (UPA), a 2-D DFT matrix can be used to perform DFT beam sweeping in both azimuth and elevation direction. It is worth noting that this can be expanded to extended DFT matrix where the phase difference is not an integer multiple of

$$\frac{2 π}{M} .$$

On the other hand, chirp beams have parameters that enable the beams to be widened. Chirp beams can be used to provide a trade-off between beam width and beamforming gain.

The beams for uplink (UL) and downlink (DL), namely the TX beam and the receive (RX) beam for a UE, or the RX beam and the TX beam for a BS, may differ due to different requirements as well. For example, for relatively robust communication, one beam used may be wider than another. In another example, a beam carrying reference signals to more than one UE may be wider to cover these UEs, compared to a beam for a single UE. In a third example, high rate requirements may require the beam to be as narrow as possible.

### SUMMARY

Power control systems and methods are provided that incorporate the effects of beamforming gain offset into uplink power control. Beamforming gain offset occurs in situations where downlink reference beams are different from uplink communication beams. Methods are provided of estimating beamforming gain offsets at the UE and the BS and incorporating these into a power control formula. At least one parameter relating to a beamforming gain offset between uplink and downlink beamformers at the UE and/or the BS is communicated between the UE and the BS. The UE transmits, and the BS receives, an uplink signal that has a transmit power that is based in part on the at least one parameter. The parameter can be a direct indication of one or more of the offsets or can be another parameter that incorporates the effect of one or more of the offsets.

According to one aspect of the present disclosure, there is provided a method in a network device comprising: communicating at least one parameter relating to a beamforming gain offset between uplink and downlink beamformers at an apparatus or relating to a beamforming gain offset between uplink and downlink beamformers at a network device or relating to a beamforming gain offset between uplink and downlink beamformers at an apparatus and to a beamforming gain offset between uplink and downlink beamformers at a network device; receiving an uplink signal, the uplink signal with a transmit power that is based in part on the at least one parameter.

Advantageously, by incorporating the effects of beamforming gain offset at the apparatus and/or the network device, more accurate power control can be achieved. This may allow a reduction in the transmit power at the apparatus, improving power control and/or reducing interference.

In some embodiments, the method further comprises transmitting a power control command that takes into account the beamforming gain offset between uplink and downlink beamformers at the network device.

Advantageously, existing power control command signalling can be used; the transmitted command takes into account the beamforming gain offset at the network device.

In some embodiments, said communicating comprises receiving a first parameter relating to a beamforming gain offset between uplink and downlink beamformers at the apparatus, wherein the power control command also takes into account the beamforming gain offset between uplink and downlink beamformers at the apparatus.

Advantageously, existing power control command signalling can be used; the transmitted command takes into account the beamforming gain offset at the network device and at the UE. Existing formulas for power control can be used.

In some embodiments, said communicating at least one parameter comprises receiving a first parameter relating to the beamforming gain offset between uplink and downlink beamformers at the apparatus and transmitting a second parameter relating to a combined power offset that combines the beamforming gain offset between uplink and downlink beamformers at the apparatus and the beamforming gain offset between uplink and downlink beamformers at the network device.

In some embodiments, the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS , UE} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the modulation and coding scheme (MCS) changes;
f_{TPC} is indicated in a power control command in a downlink control information (DCI); and
Δ_{BS,UE} is the combined power offset.

In some embodiments, said communicating at least one parameter comprises receiving a first parameter relating to the beamforming gain offset between uplink and downlink beamformers at the apparatus and transmitting a second parameter relating to the beamforming gain offset between uplink and downlink beamformers at the network device.

In some embodiments, the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS} + {Δ}_{UE} \}$$

where: P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes;
f_{TPC} is indicated in a power control command in a DCI;
Δ_{BS} is the beamforming gain offset between uplink and downlink beamformers at the network device; and
Δ_{UE} is the beamforming gain offset between uplink and downlink beamformers at the apparatus.

In some embodiments, said communicating at least one parameter comprises receiving a first parameter relating to the beamforming gain offset between uplink and downlink beamformers at the apparatus, the method further comprising: transmitting a power control command that is based on both the beamforming gain offset between uplink and downlink beamformers at the apparatus and the beamforming gain offset between uplink and downlink beamformers at the network device.

In some embodiments, the power control command indicates a value for f_{TPC} that is based on both the beamforming gain offset between uplink and downlink beamformers at the apparatus and the beamforming gain offset between uplink and downlink beamformers at the network device, and the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes.

In some embodiments, said communicating at least one parameter comprises receiving a first parameter relating to a beamforming gain offset between uplink and downlink beamformers at the apparatus, the method further comprising: transmitting a power control command that is based on the beamforming gain offset between uplink and downlink beamformers at the network device.

In some embodiments, the power control command indicates a value for f_{TPC} that is based on the beamforming gain offset between uplink and downlink beamformers at the network device, and the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{UE} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
4tf is an apparatus power adjustment based on the MCS changes;
Δ_{UE} is the beamforming gain offset between uplink and downlink beamformers at the apparatus.

In some embodiments, the method further comprises: the network device estimating a beamforming gain offset between uplink and downlink beamformers at the apparatus; wherein said communicating at least one parameter comprises transmitting a parameter relating to a combined power offset that combines the estimated beamforming gain offset between uplink and downlink beamformers at the apparatus and the beamforming gain offset between uplink and downlink beamformers at the network device.

In some embodiments, the method further comprises: the network device estimating a beamforming gain offset between uplink and downlink beamformers at the apparatus; wherein said communicating at least one parameter comprises transmitting a power control command that is based on both the estimated beamforming gain offset between uplink and downlink beamformers at the apparatus and the beamforming gain offset between uplink and downlink beamformers at the network device.

According to another aspect of the present disclosure, there is provided a network device comprising: a processor and memory, the network device configured to execute the method of as described herein.

According to another aspect of the present disclosure, there is provided a method in an apparatus comprising: communicating at least one parameter relating to a beamforming gain offset between uplink and downlink beamformers at the apparatus or relating to a beamforming gain offset between uplink and downlink beamformers at a network device or relating to a beamforming gain offset between uplink and downlink beamformers at the apparatus and to a beamforming gain offset between uplink and downlink beamformers at a network device; transmitting an uplink signal, the uplink signal with a transmit power that is based in part on the at least one parameter.

In some embodiments, the method further comprises receiving a power control command that takes into account the beamforming gain offset between uplink and downlink beamformers at the network device.

In some embodiments, said communicating comprises transmitting a first parameter relating to a beamforming gain offset between uplink and downlink beamformers at the apparatus, wherein the power control command also takes into account the beamforming gain offset between uplink and downlink beamformers at the apparatus.

In some embodiments, said communicating at least one parameter comprises transmitting a first parameter relating to the beamforming gain offset between uplink and downlink beamformers at the apparatus and receiving a second parameter relating to a combined power offset that combines the beamforming gain offset between uplink and downlink beamformers at the apparatus and the beamforming gain offset between uplink and downlink beamformers at the network device.

In some embodiments, the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS , UE} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes;
f_{TPC} is indicated in a power control command in a DCI; and
Δ_{BS,UE} is the combined power offset.

In some embodiments, said communicating at least one parameter comprises transmitting a first parameter relating to the beamforming gain offset between uplink and downlink beamformers at the apparatus and receiving a second parameter relating to the beamforming gain offset between uplink and downlink beamformers at the network device.

In some embodiments, the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS} + {Δ}_{UE} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes;
f_{TPC} is indicated in a power control command in a DCI;
Δ_{BS} is the beamforming gain offset between uplink and downlink beamformers at the network device; and
Δ_{UE} is the beamforming gain offset between uplink and downlink beamformers at the apparatus.

In some embodiments, said communicating at least one parameter comprises transmitting a first parameter relating to the beamforming gain offset between uplink and downlink beamformers at the apparatus, the method further comprising: receiving a power control command that is based on both the beamforming gain offset between uplink and downlink beamformers at the apparatus and the beamforming gain offset between uplink and downlink beamformers at the network device.

In some embodiments, the power control command indicates a value for f_{TPC} that is based on both the beamforming gain offset between uplink and downlink beamformers at the apparatus and the beamforming gain offset between uplink and downlink beamformers at the network device, and the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes.

In some embodiments, said communicating at least one parameter comprises transmitting a first parameter relating to a beamforming gain offset between uplink and downlink beamformers at the apparatus, the method further comprising: receiving a power control command that is based on the beamforming gain offset between uplink and downlink beamformers at the network device.

In some embodiments, the power control command indicates a value for f_{TPC} that is based on the beamforming gain offset between uplink and downlink beamformers at the network device, and the transmit power is given by:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{UE} \}$$

where:
P_{cmax} is an apparatus configured maximum output power;
Pₒ is a target received power;
μ is a numerology,
M is a number of resource blocks;
α is a pathloss compensation factor between 0 and 1;
PL is a pathloss measured based on apparatus receive beam and BS transmit beam;
Δ_{tf} is an apparatus power adjustment based on the MCS changes;
Δ_{UE} is the beamforming gain offset between uplink and downlink beamformers at the apparatus.

In some embodiments, said communicating at least one parameter comprises receiving a parameter relating to a combined power offset that combines an estimate made by the network device of a beamforming gain offset between uplink and downlink beamformers at the apparatus and the beamforming gain offset between uplink and downlink beamformers at the network device.

In some embodiments, said communicating at least one parameter comprises receiving a power control command that is based on both an estimate made by the network device of a beamforming gain offset between uplink and downlink beamformers at the apparatus and the beamforming gain offset between uplink and downlink beamformers at the network device.

According to another aspect of the present invention, there is provided apparatus comprising: a processor and memory, the apparatus configured to execute the method as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5 is a signal flow diagram of a first method of communicating using a power control method that incorporates the effects of beamforming gain offsets;

FIG. 6 is a signal flow diagram of a second method of communicating using a power control method that incorporates the effects of beamforming gain offsets;

FIG. 7 is a signal flow diagram of a third method of communicating using a power control method that incorporates the effects of beamforming gain offsets;

FIG. 8 is a signal flow diagram of a fourth method of communicating using a power control method that incorporates the effects of beamforming gain offsets;

FIG. 9 is a signal flow diagram of a fifth method of communicating using a power control method that incorporates the effects of beamforming gain offsets;

FIG. 10 is a signal flow diagram of a sixth method of communicating using a power control method that incorporates the effects of beamforming gain offsets; and

FIGS. 11 and 12 are flowcharts of methods of communicating using a power control method that incorporates the effects of beamforming gain offsets.

### DETAILED DESCRIPTION

It should be noted that beamforming can be performed at both the BS side and the UE side. The beamforming gain from both the BS and the UE has to be considered in the determination of TX power. With flexible beamforming, the beamforming gain from the BS and the UE can rapidly change to reflect the best transmission direction or coverage range.

The UE UL TX power is controlled because the UE itself is equipped with a limited battery. Battery power is a relatively precious resource for the UE and should be used wisely. In addition, UE UL transmit power that is too high or too low can lead to some adverse consequences. For example, if the UE UL transmit power is too low, the BS receive power can be lower than expected. This may cause a high block error rate (BLER) which can result in poor communication quality. In another example, if the UE UL transmit power is too high, the BS receive power can be higher than expected. There are three consequences of this. Firstly, more UE battery is wasted. Secondly, the higher UE transmission power may cause higher interference to neighboring cells. Lastly, the UE desired transmit power may be outside the range of transmit power that the UE is capable of producing.

In 3GPP 36.213, if a UE transmits a physical uplink shared channel (PUSCH) on an active UL bandwidth part (BWP) b of carrier f of serving cell c using parameter set configuration with index j and PUSCH power control adjustment state with index l, the UE determines the PUSCH transmission power P_{PUSCH,b,f,c}(i, j, q_{d}, l) in PUSCH transmission occasion i as

$${P}_{PUSCH , b , f , c} ( i , j , {q}_{d} , l ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

where,
P_{CMAX,f,c}(i) is the UE configured maximum output power for carrier f of serving cell c in PUSCH transmission occasion i.
P_{O_PUSCH,b,f,c}(j) is the nominal UE transmit power, represents the transmit power when allocated a single resource block with 15 kHz subcarrier spacing and 0 dB pathloss on active UL BWP b of carrier f of serving cell c.

$${M}_{RB , b , f , c}^{PUSCH} ( i )$$

is the bandwidth of the PUSCH resource assignment expressed in number of resource blocks for PUSCH transmission occasion i on active UL BWP b of carrier f of serving cell c and μ is a SCS configuration.
PL_{b,f,c}(q_{d}) is a downlink pathloss estimate in dB calculated by the UE using reference signal (RS) index q_{d} for the active DL BWP of carrier f of serving cell c,
Δ_{TF,b,f,c}(i) is the UE power adjustment based on the MCS changes for each UL BWP b of each carrier f and serving cell c.
f_{b,f,c}(i, l) is the PUSCH power control adjustment state for active UL BWP b of carrier f of serving cell c in PUSCH transmission occasion i.

It should be noted that
PL_{b,f,c}(q_{d}) is measured based on a BS TX beam used for sending a pathloss reference signal, known as the PathlossReferenceRS and a UE RX beam used for measuring the PathlossReferenceRS. It includes the beamforming gain of these two beams. The PathlossReferenceRS can be a synchronization signal block (SSB) or a channel state information reference signal (CSI-RS).
Δ_{TF,b,f,c}(i) can change if the selected MCS changes.
f_{b,f,c}(i, l) is a feedback from BS transmit power control (TPC) command in a DCI.
   It can be seen that calculation of the UE uplink transmission power P_{PUSCH,b,f,c}(i, j, q_{d}, l) takes into consideration the beamforming gain of the DL reference beams. However, with flexible UE/BS beamforming, the uplink communication beams (i.e. the UE TX beam and the BS RX beam) may not be necessarily the same as the downlink reference beams (i.e. the BS TX beam and the UE RX beam). Therefore, the calculated P_{PUSCH,b,f,c}(i, j, q_{d}, l) may not necessarily be suitable if the UE TX beam is different from the UE RX beam used for measuring PathlossReferenceRS, and/or if the BS RX beam is different from BS TX beam used for sending PathlossReferenceRS.

The following are four scenarios to show how the calculated P_{PUSCH,b,f,c}(i, j, q_{d}, l) does not consider the actual beamforming gain of the uplink communication beams.

Scenario 1: The UE TX beam width is narrower than that of the UE RX beam with more beamforming gain. If the current 3GPP standard framework is used to calculate P_{PUSCH,b,f,c}(i, j, q_{d}, l) as UE uplink transmission power, the BS RX power will be higher than expected because the UE assumes the PL is higher than what it actually is. This could lead to UE battery waste and power leakage to adjacent channels and more interference to adjacent cells.

Scenario 2: The UE TX beam width is wider than that of the UE RX beam with less beamforming gain. If the current 3GPP standard framework is used to calculate P_{PUSCH,b,f,c}(i, j, q_{d}, l) as UE uplink transmission power, the BS RX power will be lower than expected due to an underestimation of the UL PL by UE. This could result in a higher BLER and poor communication quality resulting in increased negative acknowledgement (NAK) signalling and retransmissions.

Scenario 3: The BS RX beam width is narrower than that of the BS TX beam with more beamforming gain. If the current 3GPP standard framework is used to calculate P_{PUSCH,b,f,c}(i, j, q_{d}, l) as UE uplink transmission power, the BS RX power will be higher than expected and this will have the same negative effect as Scenario 1. It is possible that the BS sends the power adjustment in f_{b,f,c}(i, l) via DCI or through radio resource control (RRC) signalling for the offset adjustment. However, there is only limited flexibility. There are two bits in the DCI field for the UE to adjust its power and the RRC signalling is often slow and is only there to combat the width adjustment of the beam for SSB.

Scenario 4: The BS RX beam width is wider than that of the BS TX beam with less beamforming gain. If the current 3GPP standard framework is used to calculate P_{PUSCH,b,f,c}(i, j, q_{d}, l) as UE uplink transmission power, the BS RX power will be lower than expected, and the result is the same as that for Scenario 2. It is possible that the BS sends the power adjustment in f_{b,f,c}(i, l) via DCI or RRC. However, there is only limited flexibility. There are two bits in the field for the UE to adjust its power and RRC is slow on this front.

In some methods, UE UL power control considers the beamforming gains associated with the beams used to transmit and receive the DL reference signal. When the UL communication beams (transmit and receive) are different from the DL reference beams in terms of beam shape and/or beam direction, the beamforming gain during the UL communication will be different from that experienced by the DL reference signal. There is an offset between the beamforming gain from the communication beams and the DL reference beams at the BS and/or UE, and the beamforming gain offset is not considered in these power control methods.

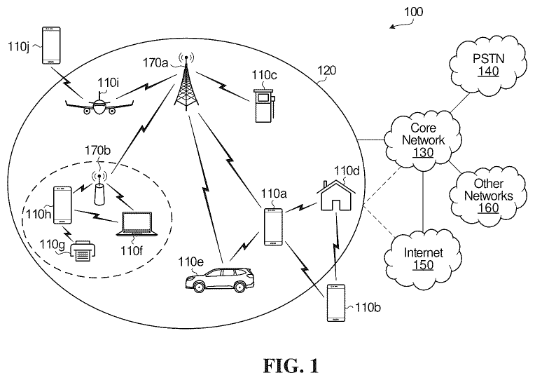

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

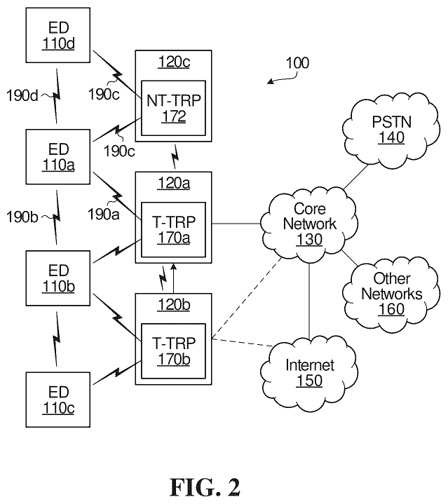

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130 and may or may not employ the same radio access technology as RAN 120a, RAN 120b or both. The core network 130 may also serve as a gateway access between (i) the RANS 120a and 120b or EDs 110a 110b, and 110c or both, and (ii) other networks (such as the PSTN 140, the internet 150, and the other networks 160). In addition, some, or all, of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies and may incorporate multiple transceivers necessary to support such operation.

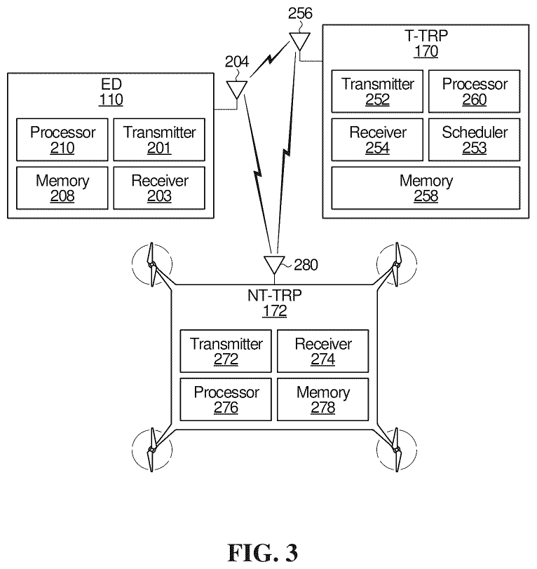

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random-access memory (RAM), read-only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signalling from the downlink transmission (e.g. by detecting and/or decoding the signalling). An example of signalling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signalling, e.g. to configure one or more parameters of the ED 110 and/or one or more parameters of the NT-TRP 172. Any signalling generated by the processor 260 is sent by the transmitter 252. Note that “signalling”, as used herein, may alternatively be called control signalling. Dynamic signalling may be transmitted in a control channel, e.g. a physical downlink control channel (PDCCH), and static or semi-static higher layer signalling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating and decoding received symbols. In some embodiments, the processor 276 implements the transmit beamforming and/or receive beamforming based on beam direction information (e.g. BAI) received from T-TRP 170. In some embodiments, the processor 276 may generate signalling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

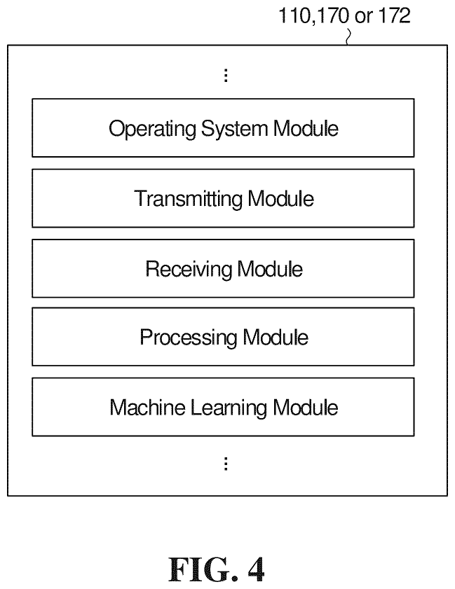

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor, for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Embodiments of the application will now be described that incorporate the effects of beamforming gain offset into uplink power control. In some embodiments, the UE/apparatus or BS/network devices of above-described FIGS. 1 to 4 are configured to implement one or more of the described methods.

For simplicity, the expression for power control is simplified by dropping the notations in the parenthesis and some subscripts of the parameters as follows.

$${P}_{tx} = min \{ {P}_{cmax} , {P}_{0} + 10 {log}_{10} ( {2}^{μ} M ) + α \cdot PL + {Δ}_{tf} + {f}_{TPC} \}$$

where:
P_{cmax} is a UE configured maximum output power;
Pₒ is a target received power;
μ is a numerology,
M is a number of resource blocks;
α is a pathloss compensation factor between 0 and 1;
PL is a pathloss measured based on UE receive beam and BS transmit beam;
Δ_{tf} is a UE power adjustment based on the MCS changes; and
f_{TPC} is indicated in a power control command in a DCI.

In accordance with embodiments of the application, cases are considered where the DL reference beams are different from the UL communication beams. Methods are provided of estimating and Δ_{BS} and Δ_{UE} and incorporating these into the power control formula, where:
Δ_{BS} is the estimated beamforming gain offset between the BS RX beam used for communication and the BS TX beam used to transmit a reference signal;
Δ_{UE} is the estimated beamforming gain offset between the UE TX beam used for communication and the UE RX beam used to receive the reference signal;
Δ_{BS,UE} is a term that incorporates both Δ_{BS} and Δ_{UE};
f_{TPC} is indicated in a power control command in a DCI, and may, in different embodiments, incorporate one or both of Δ_{BS} and Δ_{UE}, or may incorporate neither of Δ_{BS} and Δ_{UE}.

Beamforming gain offset at the UE, namely Δ_{UE}, is the beamforming gain of the UL beam minus the beamforming gain of the DL beam. Sometimes, and possibly in most cases, it is not necessary to calculate the absolute values of beamforming gains because it is only the difference that is of interest. For example, in a situation where the UE UL beam points to the same direction as the UE DL beam, but its beam width is only half that of the UE DL beam, then it is directly known that the beamforming gain offset is 3 dB due to this beam width adaption without calculating/estimating the beamforming gain of the two beams and performing a subtraction. Thus, the beamforming gain offset at the UE can generally be obtained with knowledge of the relative characteristics of the UL and DL beams. Similarly, the beamforming gain offset at the BS can generally be obtained with knowledge of the relative characteristics of the UL and DL beams.

The provided approaches can be applied, for example, when a UE is sending data and/or control (PUSCH, physical uplink control channel (PUCCH)) in the UL direction. The provided approach is meaningful when the BS and/or the UE are capable of analog beamforming, and can play a significant role when the DL reference beams are different from the UL communication beams.

The following embodiments are applicable to different scenarios in which the BS and UE can communicate in a way that considers the beamforming gain mismatching between DL estimation and UL communication. The communication may be related to one or more parameters including, Δ_{BS}, Δ_{UE}, Δ_{BS,UE} Or f_{TPC}. The UE may use one or more of these parameters to update its UL power as instructed.

In any of the following embodiments,
The terms Δ_{BS}, Δ_{BS,UE} or f_{TPC}, may be used by the UE as given by the BS. In other scenarios, the UE may assume default values for one or more of these values.
The term Δ_{BS} may be estimated by the BS according to the beamforming gain differences between UL RX beam and DL TX beam and some uncertainties.
The term Δ_{UE} may be estimated by the UE according to the beamforming gain differences between UL TX beam and DL RX beam and some uncertainties.
The reason why uncertainties are added is sometimes it may be too complex to calculate the exact beamforming gain differences due to different reasons.
Uncertainties that can change the beamforming gain difference may include, but are not limited to, location uncertainty, speed uncertainty, velocity uncertainty, angular uncertainty, and orientation uncertainty.

In a first embodiment, the BS has functionality, for example a module, to estimate Δ_{BS} which is the beamforming gain offset between BS RX beam gain and BS TX beam gain with some uncertainties. The UE has functionality, for example a module, to estimate Δ_{UE}, which is the beamforming gain offset between UE TX beam gain and UE RX beam gain with some uncertainties.

An example of a power control procedure for this embodiment includes a UE evaluating and informing a BS of Δ_{UE}. Next, the BS evaluates Δ_{BS} and informs the UE of the combined power offset Δ_{BS,UE}, where Δ_{BS,UE} combines the effect of both Δ_{BS} and Δ_{UE}. In a specific example, Δ_{BS,UE}=Δ_{BS}+Δ_{UE}. Next, the UE uses the updated formula Pₜₓ=min{P_{cmax}, P₀+10 log₁₀(2^{μ}M)+α·PL+Δ_{tf}+f_{TPC}+Δ_{BS,UE}} to determine transmit power.

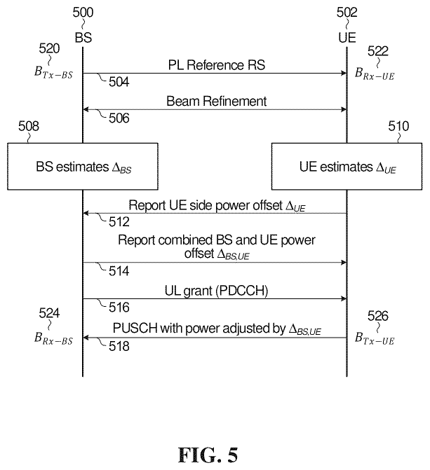

A signal flow diagram for an overall method of communicating that includes this power control procedure is depicted in FIG. 5, which shows the exchange of signals between a BS 500 and a UE 502. The method begins at 504 with the transmission of a PL reference signal, sent by a BS TX beam 520 (B_{Tx-BS}) and measured by a UE RX beam 522 (B_{Rx-UE}). The PL is measured based on these two beams. After beam refinement 506 and some other operations, the UE and the BS decide a UE TX beam 526 (B_{Tx-UE}) and a BS RX beam 524 (B_{Rx-BS}) respectively for UL communications. These two UL communications beams may not be the same as the beams 520,522 used for PL measurement. The BS estimates the BS side power offset Δ_{BS} at 508, and the UE estimates the UE side power offset Δ_{UE} at 510. At 512, the UE reports the UE side power offset Δ_{UE} to the BS, and at 514, the BS reports a combined BS and UE power offset Δ_{BS,UE} to the UE, thereby completing parts of the overall method concerning power control. Further steps relating to communication are shown at 516,518, including the transmission of an UL grant (over a physical downlink control channel) at 516, and the subsequent transmission of a PUSCH at 518 with power adjusted by Δ_{BS,UE}. More specifically, the UE determines its UL TX power based on the provided formula which incorporates the term Δ_{BS,UE} after receiving the UL grant.

It should be noted that for this and other embodiments described herein, the vehicle for communicating Δ_{BS}, Δ_{UE} Or Δ_{BS,UE} can be DCI (which may involve relatively increased overhead), MAC-CE or RRC link communication. The frequency of updating Δ_{BS}, Δ_{UE} or Δ_{BS,UE} may be at a same rate as used to update beamformers.

In a second embodiment, the BS again has functionality, for example a module, to estimate Δ_{BS} which is the beamforming gain offset between BS RX beam gain and BS TX beam gain with some uncertainties. The UE again has functionality, for example a module, to estimate Δ_{UE}, which is the beamforming gain offset between UE TX beam gain and UE RX beam gain with some uncertainties.

An example of a power control procedure for this embodiment includes a BS evaluating and informing a UE of Δ_{BS}. The UE evaluates and informs BS of Δ_{UE}. Next, the UE uses the updated formula Pₜₓ=min{P_{cmax}, P₀+10 log₁₀ (2^{μ}M)+α·PL+Δ_{tf}+f_{TPC}+Δ_{BS}+Δ_{UE}} to determine the transmit power.

It should be noted that in this embodiment, the UE may still inform BS of Δ_{UE}. The BS may use such information for interference management and resource allocation adjustment.

It should also be noted that a system may use only one of the two mechanisms used in this embodiment, meaning only the signalling associated with BS side adjustment or signalling with the UE side adjustment is present and the other one is absent. For example, only the signalling associated with Δ_{BS} may be used, or only the signalling associated with Δ_{UE} may be used. In addition, there may be cases where the beam is flexible only on one side. Also, in some cases, the effect may be considered using default values on one side, making only half the signalling is used.

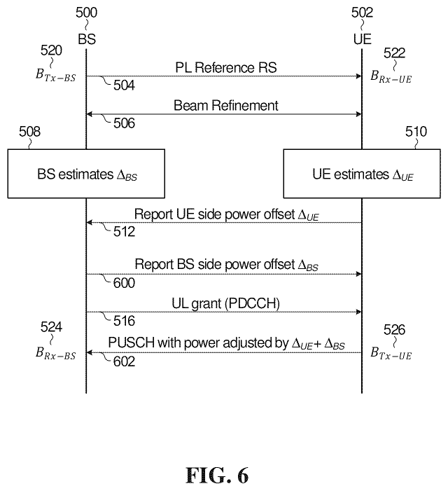

A signal flow diagram for an overall method of communicating that includes this power control procedure is depicted in FIG. 6, which again shows the exchange of signals between a BS 500 and a UE 502. The procedure is the same as described in FIG. 5, except that rather than reporting the combined power offset, in this embodiment, at 600 the BS reports the BS side power offset Δ_{BS}, and rather than transmitting PUSCH with power adjusted by Δ_{BS,UE}, in this embodiment, the PUSCH is transmitted at 602 by adjusting using Δ_{BS} received from the BS, and the Δ_{UE} determined by the UE.

In a third embodiment, the BS again has functionality, for example a module, to estimate Δ_{BS} which is the beamforming gain offset between BS RX beam gain and BS TX beam gain with some uncertainties. The UE again has functionality, for example a module, to estimate Δ_{UE}, which is the beamforming gain offset between UE TX beam gain and UE RX beam gain with some uncertainties.

An example of a power control procedure for this embodiment includes a UE evaluating and informing a BS of Δ_{UE}. The BS evaluates Δ_{BS} and incorporates the combined power offset Δ_{BS,UE} in f_{TPC} and conveys this to the UE. Next, the UE uses Pₜₓ=min{P_{cmax}, P₀+10 log₁₀ (2^{μ}M)+α·PL+Δ_{tf}+f_{TPC}} to determine the transmit power.

In this embodiment, the term f_{TPC} now includes the effect of the combined power offset Δ_{BS,UE} from both the BS and the UE. In some embodiments, the term f_{TPC} is allocated 2 bits consistent with existing implementations. In another embodiment, the term f_{TPC} is allocated more bits to provide a wider range of possible power offsets.

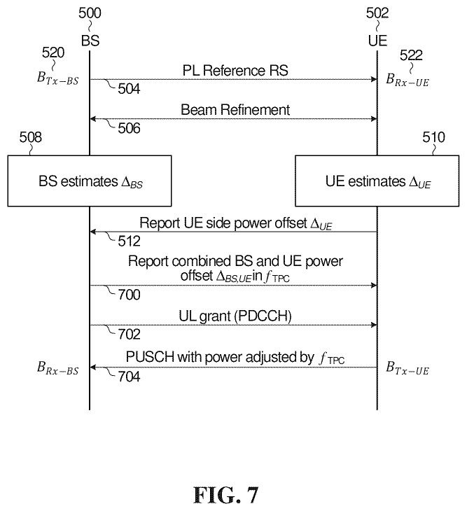

A signal flow diagram for an overall method of communicating that includes this power control procedure is depicted in FIG. 7, which again shows the exchange of signals between a BS 500 and a UE 502. Steps 504,506,508,510,512 are the same as described previously with reference to FIG. 5. At 700, the BS side reports combined power control offset Δ_{BS,UE} in f_{TPC}. At 702, the BS transmits a UL grant (PDCCH) and at 704, the PUSCH is transmitted with power adjusted by f_{TPC}.

In a fourth embodiment, the BS again has functionality, for example a module, to estimate Δ_{BS} which is the beamforming gain offset between BS RX beam gain and BS TX beam gain with some uncertainties. The UE again has functionality, for example a module, to estimate Δ_{UE}, which is the beamforming gain offset between UE TX beam gain and UE RX beam gain with some uncertainties.

An example of a power control procedure for this embodiment includes a UE evaluating and informing a BS of Δ_{UE}. The BS evaluates and incorporates Δ_{BS} in f_{TPC} and conveys this to the UE. Next, the UE uses Pₜₓ=min{P_{cmax}, P₀+10 log₁₀ (2^{μ}M)+α·PL+Δ_{tf}+f_{TPC}+Δ_{UE}} to determine the transmit power.

In this embodiment, the term f_{TPC} is used to consider the power offset from the BS, and at the UE side, the UE incorporates a term for the power offset from the UE. In some embodiments, the term f_{TPC} is allocated 2 bits consistent with existing implementations. In another embodiment, the term f_{TPC} is allocated more bits to provide a wider range of possible power offsets.

It should also be noted that similar to second embodiment described above, a system may use only one of the two mechanisms used in this embodiment, meaning only the signalling associated with BS side adjustment or signalling with the UE side adjustment is present and the other one is absent.

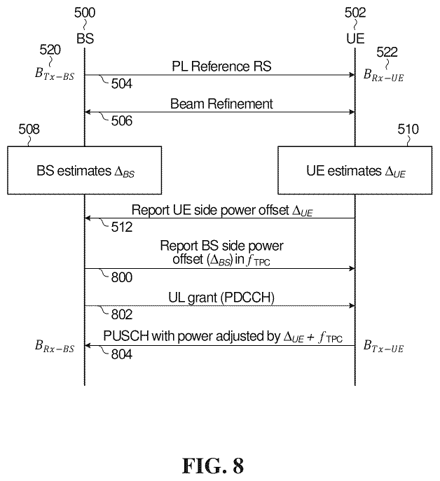

A signal flow diagram for an overall method of communicating that includes this power control procedure is depicted in FIG. 8, which again shows the exchange of signals between a BS 500 and a UE 502. Steps 504,506,508,510,512 are the same as described previously with reference to FIG. 5. At 800, the BS side reports power control offset Δ_{BS} in f_{TPC}. At 802, the BS transmits a UL grant (PDCCH) and at 804, the PUSCH is transmitted with power adjusted by f_{TPC} and Δ_{UE}.

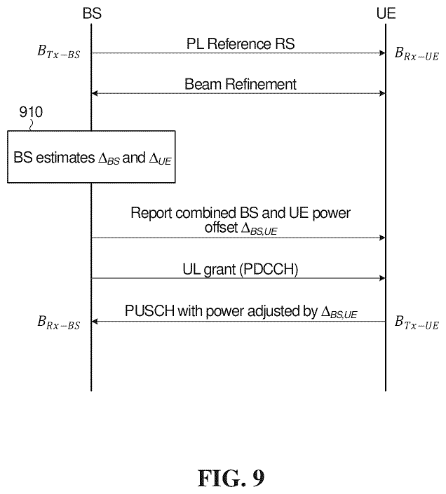

In a fifth embodiment, a BS has two modules, one as in the embodiments described above to estimate Δ_{BS} and the other one to estimate Δ_{UE}. Or both operations can be performed in a single module. The whole procedure involves the BS estimating Δ_{BS} and Δ_{UE}, the BS sending the combined power offset Δ_{BS,UE} to the UE, and the UE using Pₜₓ=min{P_{cmax}, P₀+10 log₁₀ (2^{μ}M)+α·PL+Δ_{tf}+f_{TPC}+Δ_{BS,UE}}. The fifth embodiment is very similar to the first embodiment. The only difference is Δ_{UE} is estimated by BS and will not be send by the UE. A signal flow diagram for an overall method of communicating that includes this power control procedure is depicted in FIG. 9 which shows module(s) 910 that estimate Δ_{BS} and Δ_{UE}. And is otherwise the same as FIG. 5.

This embodiment may be useful because the UE beam control, such as beam width change, may come from the BS. In this case, the BS can estimate the beamforming gain offset on the UE side.

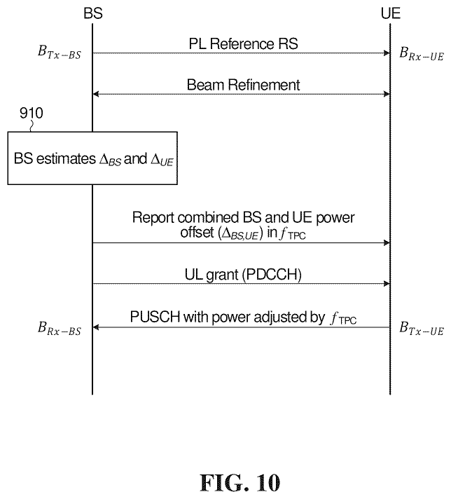

In a sixth embodiment, the BS has again two modules, one estimate Δ_{BS} and the other one to estimate Δ_{UE}. Or both operations may be performed in a single module. The whole procedure involves the BS estimates Δ_{BS} and Δ_{UE}, the BS incorporating a combined power offset Δ_{BS,UE}, in f_{TPC}, and the UE using Pₜₓ=min{P_{cmax}, P₀+10 log₁₀ (2^{μ}M)+α·PL+Δ_{tf}+f_{TPC}}. The sixth embodiment is very similar to the third embodiment. The only difference is Δ_{UE} is estimated by BS and will not be send by the UE. A signal flow diagram for an overall method of communicating that includes this power control procedure is depicted in FIG. 10 which again shows module(s) 910 that estimate Δ_{BS} and Δ_{UE}, and is otherwise the same as FIG. 7.

The described approaches are not limited to cellular/mobile communications. Rather, the same approach can be applied to any system when the UL and DL beams can be different. In another specific example, satellite communication can exploit different beamformers for UL and DL.

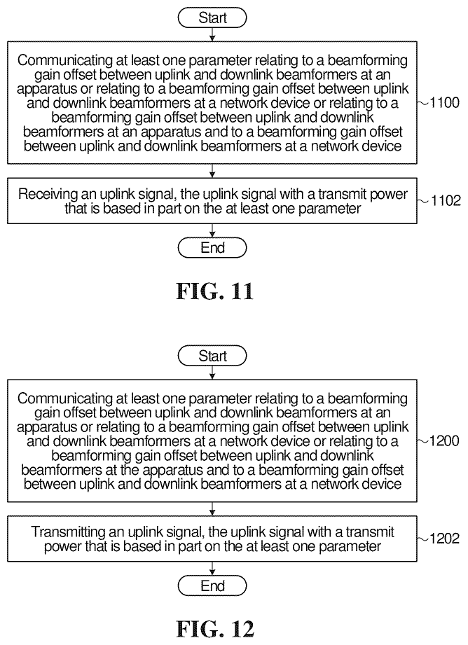

A flowchart of method performed by a network device provided by an embodiment of the application is shown in FIG. 11. The method begins in block 1100 with a network device communicating at least one parameter relating to a beamforming gain offset between uplink and downlink beamformers at a UE or relating to a beamforming gain offset between uplink and downlink beamformers at a network device or relating to a beamforming gain offset between uplink and downlink beamformers at a UE and to a beamforming gain offset between uplink and downlink beamformers at a network device. Specific examples of such communicating include:
the network device receiving Δ_{UE} from a UE;
the network device transmitting Δ_{BS} for reception by a UE;
the network device receiving Δ_{UE} from a UE and the network device transmitting Δ_{BS} for reception by a UE;
the network device transmitting Δ_{BS,UE} for reception by a UE;
the network device receiving Δ_{UE} from a UE and the network device transmitting Δ_{BS,UE} for reception by a UE;
the network device transmitting a value of f_{TPC} for reception by a UE that incorporates Δ_{BS};
the network device transmitting a value of f_{TPC} for reception by a UE that incorporates Δ_{BS,UE}.
   The method continues in block 110202 with the network device receiving an uplink signal, the uplink signal with a transmit power that is based in part on the at least one parameter.

A flowchart of method performed by an apparatus, such as a UE, provided by an embodiment of the application is shown in FIG. 12. The method begins in block 1200 with an apparatus communicating at least one parameter relating to a beamforming gain offset between uplink and downlink beamformers at a user equipment (UE) or relating to a beamforming gain offset between uplink and downlink beamformers at a network device or relating to a beamforming gain offset between uplink and downlink beamformers at a UE and to a beamforming gain offset between uplink and downlink beamformers at a network device. Specific examples of such communicating include:
the apparatus transmitting Δ_{UE} to a BS/network device;
the apparatus receiving Δ_{BS} from a BS/network device;
the apparatus transmitting Δ_{UE} to a BS/network device and apparatus receiving Δ_{BS} from a BS/network device;
the apparatus receiving Δ_{BS,UE} from a BS/network device;
the apparatus transmitting Δ_{UE} to a BS/network device and the apparatus receiving Δ_{BS,UE} from a BS/network device;
the apparatus receiving a value of f_{TPC} from a BS/network device that incorporates Δ_{BS};
the apparatus receiving a value of f_{TPC} from a BS/network device that incorporates Δ_{BS,UE}.
   The method continues in block 1202 with the apparatus transmitting an uplink signal, the uplink signal with a transmit power that is based in part on the at least one parameter.

A first example of a power control formula that can be used with the embodiments of FIGS. 11 and 12 is:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS , UE} \}$$

for embodiments in which Δ_{BS,UE} is conveyed to the apparatus. More generally, any power control formula of the following form may be applied in other embodiments:

$${P}_{tx} = min \{ {P}_{cmax} , K 1 + {Δ}_{BS , UE} \}$$

where K1 is a term based on other parameters.

A second example of a power control formula that can be used with the embodiments of FIGS. 11 and 12 is:

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{BS} + {Δ}_{UE} \}$$

for embodiments in which Δ_{BS} is conveyed to the apparatus. More generally, any power control formula of the following form may be applied in other embodiments:

$${P}_{tx} = min \{ {P}_{cmax} , K 1 + {Δ}_{BS} \}$$

where K1 is a term based on other parameters.

A third example of a power control formula that can be used with the embodiments of FIGS. 11 and 12 is:

$${P}_{tx} = min \{ {P}_{cmax} , {P}_{0} + 10 {log}_{10} ( {2}^{μ} M ) + α \cdot PL + {Δ}_{tf} + {f}_{TPC} \}$$

where f_{TPC} incorporates the effect of Δ_{BS,UE}.

A fourth example of a power control formula that can be used in the embodiments of FIGS. 11 and 12 is

$${P}_{tx} = min \{ {P}_{cmax} , {P}_{0} + 10 {log}_{10} ( {2}^{μ} M ) + α \cdot PL + {Δ}_{tf} + {f}_{TPC} + {Δ}_{UE} \}$$

where f_{TPC} incorporates the effect of Δ_{BS}.

More generally still, a transmit power based on the following power control formula may be used:

$${P}_{tx} = f ( {Δ}_{UE} )$$

where f is some function of Δ_{UE} and other inputs.

In another example, a transmit power based on the following power control formula may be used:

$${P}_{tx} = f ( {Δ}_{BS , UE} )$$

where f is some function of Δ_{BS,UE} and other inputs.

In another example, a transmit power based on the following power control formula may be used:

$${P}_{tx} = f ( {Δ}_{BS} , {Δ}_{UE} )$$

where f is some function of Δ_{BS}, Δ_{UE} and other inputs.

While many of the embodiment assume that the uplink transmission is a PUSCH transmission, more generally, the same approaches are applicable to other uplink communication channels such as PUCCH, sounding reference signal (SRS) and physical random access channel (PRACH).

Numerous modifications and variations of the present disclosure are possible in light of the above teachings. It is therefore to be understood that within the scope of the appended claims, the disclosure may be practiced otherwise than as specifically described herein.

1. A method in a network device comprising:
communicating at least one parameter relating to at least one of a beamforming gain offset between uplink and downlink beamformers at an apparatus or a beamforming gain offset between uplink and downlink beamformers at the network device; and
receiving an uplink signal, the uplink signal with a transmit power based in part on the at least one parameter.

2. The method of claim 1, further comprising:
transmitting a power control command based on the beamforming gain offset between uplink and downlink beamformers at the network device.

3. The method of claim 2, wherein the communicating comprises:
receiving a first parameter relating to the beamforming gain offset between the uplink and downlink beamformers at the apparatus, wherein the power control command is further based on the beamforming gain offset between the uplink and downlink beamformers at the apparatus.

4. The method of claim 1, wherein the communicating the at least one parameter comprises:
receiving a first parameter relating to the beamforming gain offset between the uplink and downlink beamformers at the apparatus; and
transmitting a second parameter relating to a combined power offset that combines the beamforming gain offset between the uplink and downlink beamformers at the apparatus and the beamforming gain offset between the uplink and downlink beamformers at the network device.

5. The method of claim 1, wherein the communicating the at least one parameter comprises:
receiving a first parameter relating to the beamforming gain offset between the uplink and downlink beamformers at the apparatus; and
transmitting a second parameter relating to the beamforming gain offset between the uplink and downlink beamformers at the network device.

6. A device comprising:
at least one processor; and
a memory, the device is configured to perform operations including:
communicating at least one parameter relating to at least one of a beamforming gain offset between uplink and downlink beamformers at an apparatus a beamforming gain offset between uplink and downlink beamformers at the device; and
receiving an uplink signal, the uplink signal with a transmit power based in part on the at least one parameter.

7. The device of claim 6, the operations further comprising:
transmitting a power control command based on the beamforming gain offset between uplink and downlink beamformers at the device.

8. The device of claim 7, wherein the communicating comprises:
receiving a first parameter relating to the beamforming gain offset between the uplink and downlink beamformers at the apparatus, wherein the power control command is further based on the beamforming gain offset between the uplink and downlink beamformers at the apparatus.

9. The device of claim 6, wherein the communicating the at least one parameter comprises:
receiving a first parameter relating to the beamforming gain offset between the uplink and downlink beamformers at the apparatus; and
transmitting a second parameter relating to a combined power offset that combines the beamforming gain offset between the uplink and downlink beamformers at the apparatus and the beamforming gain offset between the uplink and downlink beamformers at the device.

10. The device of claim 6 wherein the communicating the at least one parameter comprises:
receiving a first parameter relating to the beamforming gain offset between the uplink and downlink beamformers at the apparatus; and
transmitting a second parameter relating to the beamforming gain offset between the uplink and downlink beamformers at the device.

11. A method in an apparatus comprising:
communicating at least one parameter relating to at least one of a beamforming gain offset between uplink and downlink beamformers at the apparatus or a beamforming gain offset between uplink and downlink beamformers at a network device; and
transmitting an uplink signal, the uplink signal with a transmit power based in part on the at least one parameter.

12. The method of claim 11, further comprising:
receiving a power control command based on the beamforming gain offset between uplink and downlink beamformers at the network device.

13. The method of claim 12, wherein the communicating comprises:
transmitting a first parameter relating to the beamforming gain offset between the uplink and downlink beamformers at the apparatus, wherein the power control command is further based on the beamforming gain offset between the uplink and downlink beamformers at the apparatus.

14. The method of claim 11, wherein the communicating the at least one parameter comprises:
transmitting a first parameter relating to the beamforming gain offset between the uplink and downlink beamformers at the apparatus; and
receiving a second parameter relating to a combined power offset that combines the beamforming gain offset between the uplink and downlink beamformers at the apparatus and the beamforming gain offset between the uplink and downlink beamformers at the network device.

15. The method of claim 11, wherein the communicating the at least one parameter comprises:
transmitting a first parameter relating to the beamforming gain offset between the uplink and downlink beamformers at the apparatus; and
receiving a second parameter relating to the beamforming gain offset between the uplink and downlink beamformers at the network device.

16. An apparatus comprising:
at least one processor; and
a memory, the apparatus configured to perform operations including:
communicating at least one parameter relating to at least one of a beamforming gain offset between uplink and downlink beamformers at the apparatus or a beamforming gain offset between uplink and downlink beamformers at a network device; and
transmitting an uplink signal, the uplink signal with a transmit power based in part on the at least one parameter.

17. The apparatus of claim 16, the operations further comprising:
receiving a power control command based on the beamforming gain offset between uplink and downlink beamformers at the network device.

18. The apparatus of claim 17, wherein the communicating comprises:
transmitting a first parameter relating to the beamforming gain offset between the uplink and downlink beamformers at the apparatus, wherein the power control command is further based on the beamforming gain offset between the uplink and downlink beamformers at the apparatus.

19. The apparatus of claim 16, wherein the communicating the at least one parameter comprises:
transmitting a first parameter relating to the beamforming gain offset between the uplink and downlink beamformers at the apparatus; and
receiving a second parameter relating to a combined power offset that combines the beamforming gain offset between the uplink and downlink beamformers at the apparatus and the beamforming gain offset between the uplink and downlink beamformers at the network device.

20. The apparatus of claim 16, wherein the communicating the at least one parameter comprises:
transmitting a first parameter relating to the beamforming gain offset between the uplink and downlink beamformers at the apparatus; and
receiving a second parameter relating to the beamforming gain offset between the uplink and downlink beamformers at the network device.
